(19) United States
(12) Patent Application Publication
(10) Pub. No.: US 2004/0106713 A1
(43) Pub. Date: Jun. 3, 2004

(54) Use of additives in compounds containing macrocyclic poly(alkylene dicarboxylate) oligomers

(76) Inventor: Roger W. Avakian, Aurora, OH (US)

Correspondence Address: John H. Hornickel, PolyOne Corporation, 33587 Walker Road, Avon Lake, OH, 44012, US

(21) Appl. No.: 10/713,317

(22) Filed: Nov. 14, 2003

Related U.S. Application Data
(60) Provisional application No. 60/430,631, filed on Dec. 3, 2002.

(51) Int. Cl. C08K 3/08; C08K 3/04; C08K 3/38

(52) U.S. Cl. 524/404; 524/439; 524/495

(57) ABSTRACT

A thermoplastic compound is disclosed comprising a macrocyclic poly(alkylene dicarboxylate) oligomer and an effective amount of a property-modifying additive selected from the group consisting of a thermal conductivity additive, an electrical conductivity additive, a sound dampening additive, an ionizing-radiation-opacity additive, an atomic-particle-moderating additive, and combinations thereof. Preferred macrocyclic poly(alkylene dicarboxylate) oligomers are cyclic polybutylene terephthalate and cyclic polyethylene terephthalate. The property-modifying additives enhance the existing manufacturing and use performance of the macrocyclic poly(alkylene dicarboxylate) oligomers.

### CLAIM OF PRIORITY

This application claims priority from U.S Provisional Patent Application Serial Number 60/430,631 bearing Attorney Docket Number 1200216 and filed 0n Dec. 3, 2002.

### FIELD OF THE INVENTION

This invention relates to compounds containing macrocyclic poly(alkylene dicarboxylate) oligomers and specific additives included for specific purposes.

### BACKGROUND OF THE INVENTION

People benefit from plastic articles. From their invention in the mid-20^{th} Century until the present, thermoplastic polymers have become the composition of many consumer products. Such products are relatively lightweight, sturdy, and corrosion resistant.

Thermoplastic polymers that have properties, which approach the beneficial physical and chemical properties of thermoset polymers, are highly desired in the plastics industry, because the consumer has a strong plastic product, but the manufacturer has made that product using thermoplastic manufacturing techniques. Moreover, the thermoplastic polymer can be recycled for new uses.

One class of thermoplastic polymers, which approach the beneficial physical and chemical properties of thermoset plastics is macrocyclic poly(alkylene dicarboxylate) oligomers. These polymers, also known as MPO's, are well reported in the literature as having preferred thermoplastic manufacturing characteristics and preferred thermoset use characteristics. One manufacturer, Cyclics Corporation, reports on its CBT™ resin products at www.cyclics.com.

CBT™ Resins of cyclic poly(butylene terephthalate) (“PBT”) are solid (powder, pellet, flake) at room temperature and when heated are fully molten above 150° C. (300° F.), with a viscosity in the range of 150 mPa.s (150 cP), and drops in viscosity to below 20 mPa.s (20 cP) at 180° C. (355° F.). When mixed with specific tin or titanium polymerization catalysts the PBT rings in cyclical form open and connect (i.e., polymerize) to form high molecular weight PBT thermoplastic without exotherm or off-gassing. Full polymerization can occur in tenth's of seconds or many minutes depending on the temperature and type of catalyst used. This initial water-like viscosity allows rapid and excellent wet-out of fillers and fiber reinforcements. Very high filler loadings of 80 volume percent or greater have been achieved. The combination of low viscosity and rapid polymerization allows for fast processing in many different applications.

These CBT™ Resins exhibit the following properties according to Cyclics Corporation: Commercially available PBT grades exhibit a wide range of mechanical, electrical and thermal properties when combined with typical polymer additives and fillers, making PBT thermoplastic a very versatile material. Some of these material advantages include stiffness and toughness, high heat resistance in reinforced grades, chemical resistance, dimensional stability/low water absorption, electrical insulation and high arc resistance, flame retardancy, thermoformability, adaptability to post-mold operations (e.g., welding, gluing, painting), and recycling.

Further, U.S. Pat. Nos. 5,191,013, 6,436,549 and 6,436,548 describe various types of fillers that can be included during manufacture of articles containing macrocyclic poly(alkylene dicarboxylate) oligomers.

### SUMMARY OF THE INVENTION

What the art needs are more thermoplastic compounds that benefit from both macrocyclic poly(alkylene dicarboxylate) oligomers and specific additives present for specific purposes.

One aspect of the invention is a thermoplastic compound comprising a macrocyclic poly(alkylene dicarboxylate) oligomer and an effective amount of a thermal conductivity additive.

Another aspect of the invention is a thermoplastic compound comprising a macrocyclic poly(alkylene dicarboxylate) oligomer and an effective amount of an electrical conductivity additive.

Another aspect of the invention is a thermoplastic compound comprising a macrocyclic poly(alkylene dicarboxylate) oligomer and an effective amount of a sound dampening additive.

Another aspect of the invention is a thermoplastic compound comprising a macrocyclic poly(alkylene dicarboxylate) oligomer and an effective amount of an ionizing-radiation-opacity additive.

Another aspect of the invention is a thermoplastic compound comprising a macrocyclic poly(alkylene dicarboxylate) oligomer and an effective amount of an atomic-particle-moderating additive.

Another aspect of the invention is a thermoplastic compound comprising a macrocyclic poly(alkylene dicarboxylate) oligomer and an effective amount of a property-modifying additive selected from the group consisting of a thermal conductivity additive, an electrical conductivity additive, a sound dampening additive, an ionizing-radiation-opacity additive, an atomic-particle-moderating additive, and combinations thereof.

Another aspect of the invention is a method of modifying properties of a macrocyclic poly(alkylene dicarboxylate) oligomer, comprising the step of mixing into the macrocyclic poly(alkylene dicarboxylate) oligomer a property-modifying additive selected from the group consisting of a thermal conductivity additive, an electrical conductivity additive, a sound dampening additive, an ionizing-radiation-opacity additive, an atomic-particle-moderating additive, and combinations thereof.

A feature of the present invention is the combination of a processing-friendly thermoplastic polymer with certain additives that introduce certain specific physical and chemical properties, which that thermoplastic polymer alone lacks. Moreover, given the extensive literature available to one of ordinary skill in the art about macrocyclic poly(alkylene dicarboxylate) oligomers and usefulness with fillers and additives, it is unexpected that the specific certain additives disclosed herein are capable of providing the certain specific physical and chemical properties that macrocyclic poly(alkylene dicarboxylate) oligomers alone do lack.

An advantage of the present invention is that the usefulness of macrocyclic poly(alkylene dicarboxylate) oligomers is expanded by the selection of certain additives disclosed herein.

Additional features and advantages will become apparent in the following description of embodiments of the invention.

### EMBODIMENTS OF THE INVENTION

Macrocyclic poly(alkylene dicarboxylate) oligomers Macrocyclic poly(alkylene dicarboxylate) oligomers are well identified and characterized in U.S. Pat. Nos. 6,436,549; 6,436,548; 6,420,048; 6,420,047; 6,369,157; 5,710,086; 5,668,186; 5,663,282; 5,661,214; 5,648,454; 5,591,800; 5,527,976; 5,498,651; 5,466,744; 5,446,122; 5,434,244; 5,407,984; 5,389,719; 5,387,666; 5,386,037; 5,348,985; 5,231,161; 5,191,013; and 5,039,783 and in U.S. Patent Publication 20020107356; the disclosures of all of which are incorporated herein by reference. Such patents also describe the method of manufacture. Of these patents, U.S. Pat. Nos. 6,436,549; 6,436,548; 6,420,048; 6,420,047; 6,369,157; and 5,191,013 describe in the inclusion of fillers or other additives into the macrocyclic poly(alkylene dicarboxylate) oligomers.

Of the various macrocyclic poly(alkylene dicarboxylate) oligomers disclosed, macrocyclic poly(butylene terephthalate) (“cyclic PBT”) and macrocyclic poly(ethylene terephthalate) (“cyclic PET”) are desired because of their semi-crystalline nature. Cyclic PBT is preferred because of its higher speed of crystallization as compared to cyclic PET.

Property-Modifying Additives

The property-modifications desired in the present invention are thermal conductivity, electrical conductivity, high specific gravity, and sound dampening.

Non-limiting examples of thermal conductivity additives include pitch carbon, graphite, diamond, metal nitrides such as boron nitride and aluminum nitride, nanotubes of carbon and boron nitride, titanium diboride, cobalt, zinc, molybdenum, iridium, silicon, rhodium, magnesium, tungsten, berylium, aluminum, gold, copper, silver, and combinations thereof.

Non-limiting examples of electrical conductivity additives include carbon black, silver, copper, stainless steel powder or fibers, graphite, zinc, aluminum, carbon nanotubes, manganese, bismuth, samarium, titanium, zirconium, lead, antimony, vanadium, chromium, tin, palladium, platinum, iron, nickel, zinc, cobalt, molybdenum, tungsten, iridium, indium, rhodium, magnesium, berylium, aluminum, gold, silver, magnetite, bronze, brass, and combinations thereof.

Non-limiting examples of sound dampening additives include tungsten, barium sulfate, zirconium sulfate, calcium sulfate, lead, tungsten, gold, platinum, iridium, osmium, rhenium, tantalum, hafnium, palladium, rhodium, borite, magnetite, hematite, zirconia, ceramic beads, chromite, and combinations thereof.

Non-limiting examples of ionizing-radiation-opacity additives include tungsten, lead, zirconium, graphite, silicon, indium, aluminum, iridium, boron, cadmium, europium, samarium, and combinations thereof.

Non-limiting examples of ionizing-radiation-opacity additives include tungsten, lead, zirconium, graphite, silicon, indium, aluminum, iridium, boron, cadmium, europium, samarium, and combinations thereof.

The amount of various additives to be included in compounds containing macrocyclic poly(alkylene dicarboxylate) oligomers has a broad range depending on the change in scope of physical or chemical property desired.

Table A shows acceptable, desirable, and preferred ranges for each of the specific additives identified above. Acceptable values are considered an effective amount for purposes of this invention. All numerical values are approximate.

TABLE A
Ranges of Additives in Weight Percent

| | Acceptable | | Desired | | Preferred | |
|---|---|---|---|---|---|---|
| Additive | Low | High | Low | High | Low | High |
| Aluminum | 10 | 99 | 50 | 97 | 70 | 95 |
| Aluminum | 10 | 99 | 50 | 97 | 80 | 95 |
| Nitride | | | | | | |
| Antimony | 10 | 99 | 50 | 97 | 70 | 95 |
| Barium Sulfate | 10 | 99 | 50 | 97 | 70 | 95 |
| Berylium | 10 | 99 | 50 | 97 | 70 | 95 |
| Bismuth | 10 | 99 | 50 | 97 | 70 | 95 |
| Borite | 20 | 99 | 50 | 97 | 70 | 95 |
| Boron | 30 | 99 | 40 | 97 | 60 | 95 |
| Boron Nitride | 10 | 99 | 50 | 97 | 70 | 95 |
| Brass | 10 | 99 | 50 | 97 | 70 | 95 |
| Bronze | 10 | 99 | 50 | 97 | 70 | 95 |
| Cadmium | 30 | 99 | 40 | 97 | 60 | 95 |
| Calcium | 10 | 99 | 50 | 97 | 70 | 95 |
| Sulfate | | | | | | |
| Carbon Black | 15 | 99 | 50 | 97 | 60 | 95 |
| Carbon | 0.5 | 99 | 1 | 97 | 2 | 95 |
| Nanotube | | | | | | |
| Ceramic Beads | 20 | 99 | 50 | 97 | 70 | 95 |
| Chromite | 30 | 99 | 40 | 97 | 60 | 95 |
| Chromium | 10 | 99 | 50 | 97 | 70 | 95 |
| Cobalt | 10 | 99 | 50 | 97 | 70 | 95 |
| Copper | 10 | 99 | 50 | 97 | 80 | 95 |
| Diamond | 5 | 99 | 10 | 97 | 80 | 95 |
| Europium | 30 | 99 | 40 | 97 | 60 | 95 |
| Gold | 10 | 99 | 50 | 97 | 70 | 95 |
| Graphite | 2 | 99 | 50 | 97 | 80 | 95 |
| Hafnium | 10 | 99 | 50 | 97 | 70 | 95 |
| Hematite | 20 | 99 | 50 | 97 | 70 | 95 |
| Indium | 10 | 99 | 50 | 97 | 70 | 95 |
| Iridium | 10 | 99 | 50 | 97 | 70 | 95 |
| Iron | 10 | 99 | 50 | 97 | 70 | 95 |
| Lead | 10 | 99 | 50 | 97 | 70 | 95 |
| Magnesium | 10 | 99 | 50 | 97 | 70 | 95 |
| Magnetite | 10 | 99 | 50 | 97 | 70 | 95 |
| Manganese | 10 | 99 | 50 | 97 | 70 | 95 |
| Molybdenum | 10 | 99 | 50 | 97 | 70 | 95 |
| Nickel | 10 | 99 | 50 | 97 | 70 | 95 |
| Osmium | 10 | 99 | 50 | 97 | 70 | 95 |
| Palladium | 10 | 99 | 50 | 97 | 70 | 95 |
| Pitch Carbon | 2 | 99 | 50 | 97 | 75 | 95 |
| Platinum | 10 | 99 | 50 | 97 | 70 | 95 |
| Rhenium | 10 | 99 | 50 | 97 | 70 | 95 |
| Rhodium | 10 | 99 | 50 | 97 | 70 | 95 |
| Samarium | 10 | 99 | 50 | 97 | 70 | 95 |
| Silicon | 10 | 99 | 50 | 97 | 70 | 95 |
| Silver | 5 | 99 | 10 | 97 | 80 | 95 |
| Stainless Steel | 10 | 99 | 50 | 97 | 75 | 95 |
| Tantalum | 10 | 99 | 50 | 97 | 70 | 95 |
| Tin | 10 | 99 | 50 | 97 | 70 | 95 |
| Titanium | 10 | 99 | 50 | 97 | 70 | 95 |
| Titanium | 10 | 99 | 50 | 97 | 70 | 95 |
| Diboride | | | | | | |
| Tungsten | 10 | 99 | 50 | 97 | 70 | 95 |
| Vanadium | 10 | 99 | 50 | 97 | 70 | 95 |
| Zinc | 10 | 99 | 50 | 97 | 70 | 95 |
| Zirconia | 20 | 99 | 50 | 97 | 70 | 95 |
| Zirconium | 10 | 99 | 50 | 97 | 70 | 95 |
| Zirconium | 10 | 99 | 50 | 97 | 70 | 95 |
| Sulfate | | | | | | |

Usefulness of the Invention

The addition of the specific additive to accomplish addition of a specific physical property or chemical property should not detract from the performance of the macro cyclic poly(alkylene dicarboxylate) oligomers during manufacturing or use. Moreover, the addition of the specific physical or chemical property by the specific additive to macrocyclic poly(alkylene dicarboxylate) oligomers enhances the value of the macrocyclic poly(alkylene dicarboxylate) oligomers in thermoplastic applications.

For example, articles that can benefit from enhanced thermal conductivity include heat sinks such as for computer chip mounts, fuel cell radiators, aircraft leading edges, etc.

For example, articles that can benefit from enhanced electrical conductivity include bipolar plates for fuel cells, computer enclosures, electrodes, etc.

For example, articles that can benefit from enhanced sound dampening include automobile interiors, building interiors, etc.

For example, articles that can benefit from ionizing radiation opacity and/or atomic particle moderation include medical instruments, radioactive containers, radiation dosimeters, detection equipment, etc.

The invention is not limited to the above embodiments. The claims follow.

What is claimed is:

1. A thermoplastic compound, comprising:
a macrocyclic poly(alkylene dicarboxylate) oligomer and an effective amount of a property-modifying additive selected from the group consisting of a thermal conductivity additive, an electrical conductivity additive, a sound dampening additive, an ionizing-radiation-opacity additive, an atomic-particle-moderating additive, and combinations thereof.

2. The thermoplastic compound according to claim 1, wherein the macrocyclic poly(alkylene dicarboxylate) oligomer is cyclic polybutylene terephthalate or cyclic polyethylene terephthalate.

3. The thermoplastic compound according to claim 1, wherein the property-modifying additive is a thermal conductivity additive selected from the group consisting of pitch carbon, graphite, diamond, metal nitrides such as boron nitride and aluminum nitride, nanotubes of carbon and boron nitride, titanium diboride, cobalt, zinc, molybdenum, iridium, silicon, rhodium, magnesium, tungsten, berylium, aluminum, gold, copper, silver, and combinations thereof.

4. The thermoplastic compound according to claim 1, wherein the property-modifying additive is an electrical conductivity additive selected from the group consisting of carbon black, silver, copper, stainless steel powder or fibers, graphite, zinc, aluminum, carbon nanotubes, manganese, bismuth, samarium, titanium, zirconium, lead, antimony, vanadium, chromium, tin, palladium, platinum, iron, nickel, zinc, cobalt, molybdenum, tungsten, iridium, indium, rhodium, magnesium, berylium, aluminum, gold, silver, magnetite, bronze, brass, and combinations thereof.

5. The thermoplastic compound according to claim 1, wherein the property-modifying additive is a sound dampening additive selected from the group consisting of tungsten, barium sulfate, zirconium sulfate, calcium sulfate, lead, tungsten, gold, platinum, iridium, osmium, rhenium, tantalum, hafnium, palladium, rhodium, borite, magnetite, hematite, zirconia, ceramic beads, chromite, and combinations thereof.

6. The thermoplastic compound according to claim 1, wherein the property-modifying additive is an ionizing-radiation-opacity additive selected from the group consisting of tungsten, lead, zirconium, graphite, silicon, indium, aluminum, iridium, boron, cadmium, europium, samarium, and combinations thereof.

7. The thermoplastic compound according to claim 1, wherein the property-modifying additive is an atomic-particle-moderating additive selected from the group consisting of tungsten, lead, zirconium, graphite, silicon, indium, aluminum, iridium, boron, cadmium, europium, samarium, and combinations thereof.

8. The thermoplastic compound according to claim 1, wherein the macrocyclic poly(alkylene dicarboxylate) oligomer is cyclic polybutylene terephthalate.

9. A method of modifying properties of a macrocyclic poly(alkylene dicarboxylate) oligomer, comprising the step of mixing into the macrocyclic poly(alkylene dicarboxylate) oligomer a property-modifying additive selected from the group consisting of a thermal conductivity additive, an electrical conductivity additive, a sound dampening additive, an ionizing-radiation- opacity additive, an atomic-particle-moderating additive, and combinations thereof.

10. The method according to claim 9, wherein the macrocyclic poly(alkylene dicarboxylate) oligomer is cyclic polybutylene terephthalate or cyclic polyethylene terephthalate.

11. The method according to claim 9, wherein the property-modifying additive is a thermal conductivity additive selected from the group consisting of pitch carbon, graphite, diamond, metal nitrides such as boron nitride and aluminum nitride, nanotubes of carbon and boron nitride, titanium diboride, cobalt, zinc, molybdenum, iridium, silicon, rhodium, magnesium, tungsten, berylium, aluminum, gold, copper, silver, and combinations thereof.

12. The method according to claim 9, wherein the property-modifying additive is an electrical conductivity additive selected from the group consisting of carbon black, silver, copper, stainless steel powder or fibers, graphite, zinc, aluminum, carbon nanotubes, manganese, bismuth, samarium, titanium, zirconium, lead, antimony, vanadium, chromium, tin, palladium, platinum, iron, nickel, zinc, cobalt, molybdenum, tungsten, iridium, indium, rhodium, magnesium, berylium, aluminum, gold, silver, magnetite, bronze, brass, and combinations thereof.

13. The thermoplastic compound according to claim 9, wherein the property-modifying additive is a sound dampening additive selected from the group consisting of tungsten, barium sulfate, zirconium sulfate, calcium sulfate, lead, tungsten, gold, platinum, iridium, osmium, rhenium, tantalum, hafnium, palladium, rhodium, borite, magnetite, hematite, zirconia, ceramic beads, chromite, and combinations thereof.

14. The method according to claim 9, wherein the property-modifying additive is an ionizing-radiation-opacity additive selected from the group consisting of tungsten, lead, zirconium, graphite, silicon, indium, aluminum, iridium, boron, cadmium, europium, samarium, and combinations thereof

15. The method according to claim 9, wherein the property-modifying additive is an atomic-particle-moderating additive selected from the group consisting of tungsten, lead, zirconium, graphite, silicon, indium, aluminum, iridium, boron, cadmium, europium, samarium, and combinations thereof.

16. The method according to claim 9, wherein the macrocyclic poly(alkylene dicarboxylate) oligomer is cyclic polybutylene terephthalate.

17. An article made from the thermoplastic compound of claim 1.

18. The article according to claim 17, wherein the macrocyclic poly(alkylene dicarboxylate) oligomer is cyclic polybutylene terephthalate or cyclic polyethylene terephthalate.

19. The article according to claim 17, wherein the thermal conductivity additive is selected from the group consisting of pitch carbon, graphite, diamond, metal nitrides such as boron nitride and aluminum nitride, nanotubes of carbon and boron nitride, titanium diboride, cobalt, zinc, molybdenum, iridium, silicon, rhodium, magnesium, tungsten, berylium, aluminum, gold, copper, silver, and combinations thereof, and
wherein the electrical conductivity additive is selected from the group consisting of carbon black, silver, copper, stainless steel powder or fibers, graphite, zinc, aluminum, carbon nanotubes, manganese, bismuth, samarium, titanium, zirconium, lead, antimony, vanadium, chromium, tin, palladium, platinum, iron, nickel, zinc, cobalt, molybdenum, tungsten, iridium, indium, rhodium, magnesium, berylium, aluminum, gold, silver, magnetite, bronze, brass, and combinations thereof.

20. The article of claim 17, wherein the sound dampening additive is selected from the group consisting of tungsten, barium sulfate, zirconium sulfate, calcium sulfate, lead, tungsten, gold, platinum, iridium, osmium, rhenium, tantalum, hafnium, palladium, rhodium, borite, magnetite, hematite, zirconia, ceramic beads, chromite, and combinations thereof,
wherein the ionizing-radiation-opacity additive is selected from the group consisting of tungsten, lead, zirconium, graphite, silicon, indium, aluminum, iridium, boron, cadmium, europium, samarium, and combinations thereof, and
wherein the atomic-particle-moderating additive is selected from the group consisting of tungsten, lead, zirconium, graphite, silicon, indium, aluminum, iridium, boron, cadmium, europium, samarium, and combinations thereof.
